(19) United States
(12) Patent Application Publication
(10) Pub. No.: US 2006/0035654 A1
(43) Pub. Date: Feb. 16, 2006

(54) Apparatus and method for transmitting/receiving preamble in a wireless communication system

(75) Inventors: Jae-Yong Lee, Seongnam-si (KR); Tae-Gon Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/201,702

(22) Filed: Aug. 11, 2005

(30) Foreign Application Priority Data
Aug. 11, 2004 (KR) 10-2004-0063332

(51) Int. Cl. H04B 15/00

(52) U.S. Cl. 455/502; 455/509

(57) ABSTRACT

Disclosed is an apparatus and a method for transmitting/receiving synchronization mode information in a wireless communication system. A transmission apparatus in a wireless communication system enables a preamble signal in a frequency domain to carry operation mode information. A reception apparatus in a wireless communication system detects operation mode information from a preamble signal in a frequency domain.

### PRIORITY

This application claims priority to an application entitled “Apparatus and Method Transmitting/Receiving Preamble in A Wireless Communication System” filed in the Korean Intellectual Property Office on Aug. 11, 2004 and assigned Ser. No. 2004-63332, the contents of which are incorporated herein by reference.

### BACKGROUND OF THE INVENTION

1. Field of the Invention

The present invention relates to a wireless communication system, and more particularly to an apparatus and a method for transmitting/receiving a preamble in a wireless communication system.

2. Description of the Related Art

Generally, mobile communication systems employing cellular communication methods are representative of wireless communication systems. Mobile communication systems can employ a multiple access scheme in order to communicate with a plurality of users. Typical multiple access schemes used with mobile communication systems are known as a time division multiple access (TDMA) scheme, and a code division multiple access (CDMA) scheme. As CDMA systems evolve they have transformed from systems which primarily provided voice service to systems for transmitting high-speed packet data.

However, the CDMA scheme makes it difficult to transmit a greater amount of multimedia data due to limited resources inherently available (i.e. the limited number of codes). Accordingly, a multiple access scheme is required, which can distinguish between a greater number of users and transmit a greater amount of data to the users. In order to meet such a requirement, an orthogonal frequency division multiple access (OFDMA) scheme and an orthogonal frequency division multiplexing (OFDM) scheme have been suggested as multiple access schemes. Such multiple access schemes distinguish users by using a plurality of sub-channels having orthogonality, and they transmit data to the users through the sub-channels.

Accordingly, a cellular system employing the OFDMA scheme in order to transmit high-speed data has been suggested. An IEEE 802.16d standard meeting has researched and studied the OFDMA scheme in order to provide high-speed wireless Internet services. The IEEE 802.16d standard meeting suggests OFDM system standards for a variety of operation modes. Hereinafter, description about the operation modes will be described.

First, sub-channelizing schemes include four schemes such as a PUSC (Partial Usage of Sub-Channel) scheme, an FUSC (Full Usage of Sub-Channel) scheme, an optional FUSC scheme, and an AMC (Adaptive Modulation Coding) scheme.

Also, channel coding schemes include four channel coding schemes such as a CC (Convolutional Coding) scheme, a CTC (Convolutional Turbo Coding) scheme, a BTC (block turbo coding) scheme, and a ZT-CC (Zero Tail Convolutional Coding) scheme.

Hereinafter, the sub-channelizing schemes will be briefly described.

(a) The PUSC (Partial Usage of Sub-channel) scheme: this scheme makes up sub-channels by using a portion of sub-carriers assigned for data in total frequency bands.

(b) The FUSC (Full Usage of Sub-Channel) scheme: this scheme makes up sub-channels by using total sub-carriers assigned for data in total frequency bands.

(c) The optional FUSC scheme: this scheme is similar to the FUSC scheme, but has an equation different from the FUSC scheme.

(d) The AMC (Adaptive Modulation and Coding) scheme: this scheme makes up sub-channels by dividing adjacent bands in total frequency bands.

Hereinafter, a method for downlink data transmission using the sub-channelizing schemes will be described.

FIG. 1 illustrates an operation mode of a down link frame provided by the IEEE 802.16d standard. Hereinafter, the operation mode of the down link frame provided by the IEEE 802.16d standard will be described in detail with reference to FIG. 1.

As shown in FIG. 1, the down link frame includes a preamble and a frame control information header (FCH; Frame Control Header) following the preamble. The frame control information header includes sub-channelizing scheme information for symbols consecutively transmitted during a down link frame duration. As shown in FIG. 1, the PUSC scheme, the FUSC scheme, the optional FUSC scheme, and the AMC scheme are used as the sub-channelizing schemes.

Meanwhile, the preamble provides cell search information and initial synchronization information. The frame control information includes positions of downlink/uplink maps and sub-channelizing scheme information and channel coding information for making the maps. Accordingly, since consecutively-transmitted symbol information cannot be obtained before decoding the FCH, data cannot be decoded. Therefore, predetermined sub-channelizing and channel coding schemes are provided for the FCH, and the FCH is decoded on the basis of the rule described above. Then, downlink/uplink map information transferred after the decoding of the FCH is decoded.

Generally, when data communication is achieved, that is, the FCH transmission (initial transmission) is achieved, specific sub-channelizing and channel coding schemes are selected. That is, as described above, the standard defines that only one fixed operation mode, of various operation modes, is essentially applied to start data following the preamble in the down link. In other words, only one fixed operation mode can be used for the first several symbols sending the frame control information in the down link.

Currently, the IEEE 802.16d standard defines that the PUSC scheme, from among the above-described sub-channelizing schemes, and the CC (convolutional coding) scheme, from among the channel coding schemes, are essentially used for the FCH and the downlink/uplink maps. However, these restrictions are inefficient and cause communication vendors and developers to waste valuable communication resources, as it is not always desirable to use the initial sub-channelizing scheme and the initial channel coding scheme in a specific system. However, since an initial operation mode is set to one scheme, the communication vendors and the developers have to use this fixed initial operation mode. In this case, a terminal as well as the specific system must employ the fixed initial mode. Therefore, communication resources may be wasted.

In the meantime, if an initial operation mode for the frame control information symbol is not determined or if it is difficult to determine the initial operation mode, it is difficult to decode the frame control information symbols and to determine a sub-channelizing scheme and a channel coding scheme for symbols following the frame control information symbol. Accordingly, data symbols cannot be decoded. Accordingly, a method capable of exactly detecting an operation mode without wasting resources due to the above-mentioned restrictions in development of a system is required.

### SUMMARY OF THE INVENTION

Accordingly, the present invention has been made to solve the above-mentioned problems occurring in the prior art, and an object of the present invention is to provide an apparatus and a method for transmitting/receiving synchronization mode information in a wireless communication system.

In order to accomplish this object, a transmission apparatus in a wireless communication system according to the present invention enables a preamble signal in a frequency domain to carry operation mode information.

Also, in order to accomplish this object, a reception apparatus in a wireless communication system according to the present invention detects operation mode information from a preamble signal in a frequency domain.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates an operation mode of a down link frame provided by the IEEE 802.16d standard;

FIG. 2 illustrates an operation mode of a downlink frame in an IEEE 802.16d system according to one embodiment of the present invention;

FIGS. 3A and 3B illustrate structures of preamble signals in a frequency domain according to one embodiment of the present invention;

FIG. 4 is a block diagram showing a structure of a transmission apparatus in a wireless communication system according to one embodiment of the present invention;

FIG. 5A is a block diagram showing a structure of a reception apparatus in a wireless communication system according to one embodiment of the present invention;

FIG. 5B is a block diagram showing a structure of a reception apparatus in a wireless communication system according to another embodiment of the present invention;

FIG. 6 is a flowchart showing a control procedure of receiving a preamble in a reception apparatus according to one embodiment of the present invention;

FIG. 7 illustrates a structure of a preamble signal in a frequency domain according to another embodiment of the present invention;

FIGS. 8A and 8B illustrate a structure of a preamble signal in a frequency domain according to still another embodiment of the present invention;

FIG. 9 illustrates a structure of a preamble signal in a frequency domain according to still another embodiment of the present invention; and

FIG. 10 is a block diagram showing a structure of a reception apparatus in a wireless communication system according to still another embodiment of the present invention.

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

According to one embodiment of the present invention, a wireless communication system can be constructed in such a manner that an initial operation mode is not fixed, but rather is one of several optional operation modes and is carried by each of first preambles of all downlink frames. As a result, a basic system parameter can be obtained without specifying an initial operation mode.

According to one embodiment of the present invention, a preamble transmitting side can insert initial operation mode information into a preamble, and a preamble receiving side can detect the initial operation mode by using the preamble. Herein, it is preferred that the operation mode information is carried without changing or manipulating the preamble provided by the conventional standard (i.e., IEEE 802.16d).

According to the present invention, portions of preamble codes of a preamble signal provided by the IEEE 802.16d standard can be used as operation mode indicators (OMIs) in order to provide operation mode information without changing or manipulating the IEEE 802.16d standard preamble. In this case, positions of the operation mode indicators can be determined by a protocol between a transmission apparatus and a reception apparatus. Also, preamble codes can be changed so that operation mode indicators may be added within limited resources.

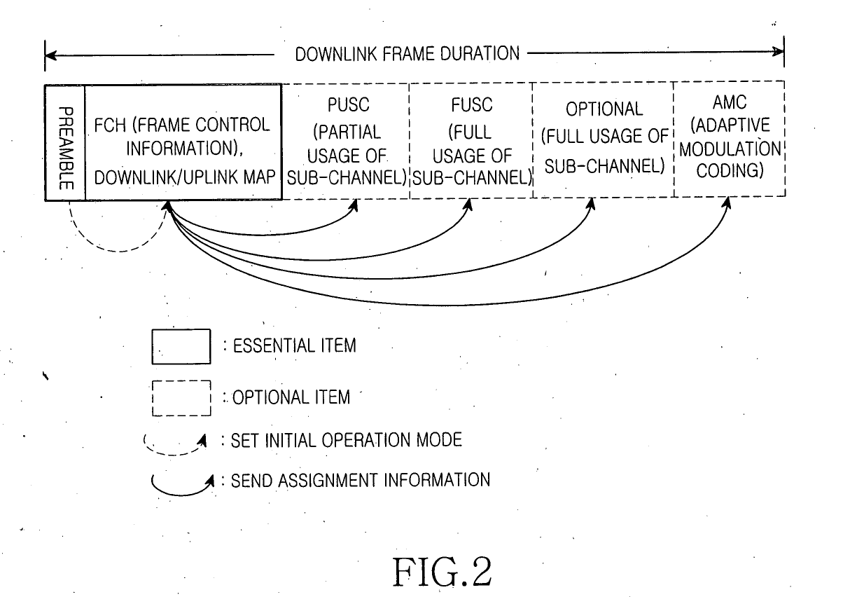

FIG. 2 illustrates an embodiment of the present invention in which an operation mode of a down link frame operates in accordance with the IEEE 802.16d standard.

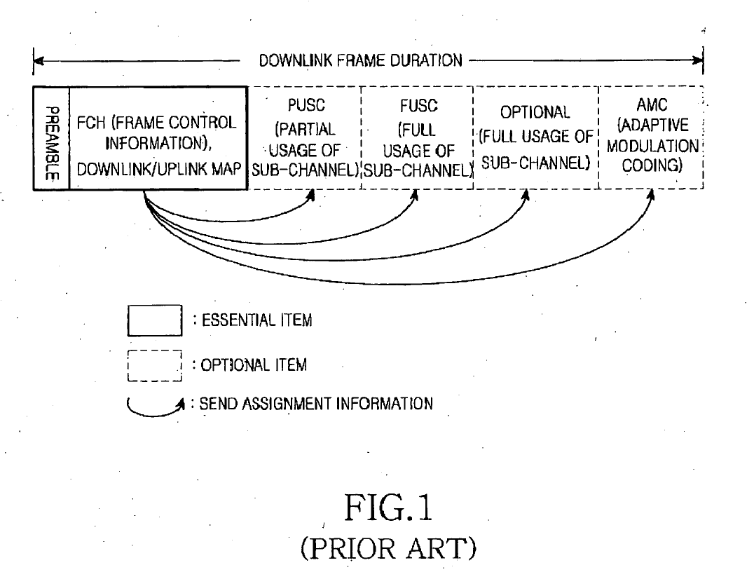

In comparison with FIG. 1, FIG. 2, illustrates a method for setting an initial operation mode according to one embodiment of the present invention is different from the conventional technique. As shown in FIG. 2, a sub-channelizing scheme and a coding scheme of the FCH can be indicated by using a preamble. In detail, the preamble indicates that only a sub-channelizing scheme is changed, that only a coding scheme is changed, or that both a sub-channelizing scheme and a coding scheme are changed through various methods as will be described below. In contrast to the conventional technique, the present invention does not only employ the PUSC scheme as the sub-channelizing scheme, but can change the sub-channelizing scheme depending on preamble patterns. Also, the present invention may change only a sub-channelizing scheme, only a coding scheme, or both of the sub-channelizing scheme and the coding scheme according to methods of mapping a preamble.

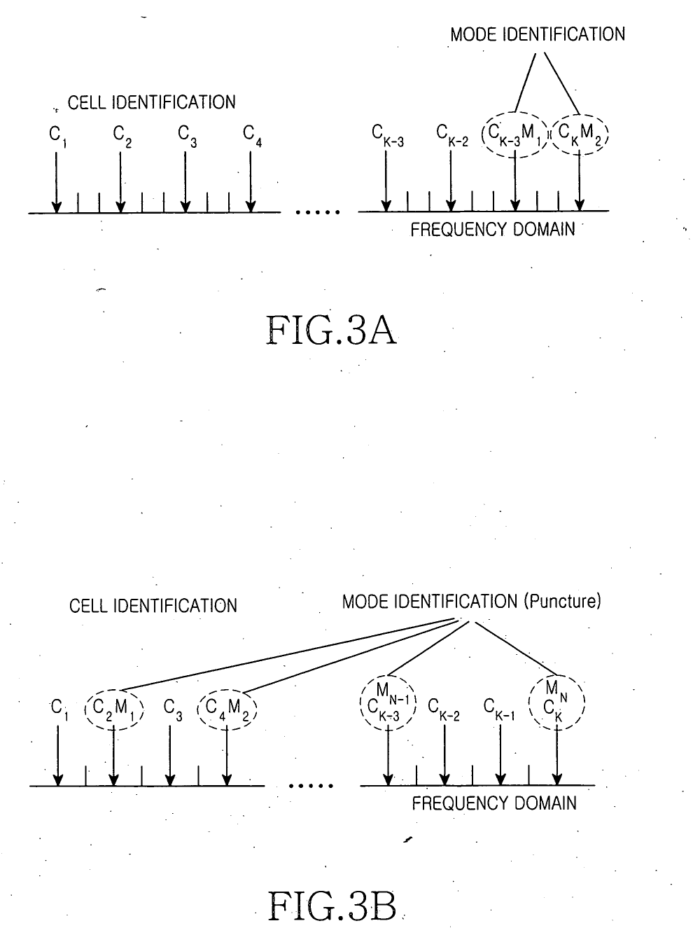

Hereinafter, a structure of a preamble signal for changing one of the sub-channelizing scheme and the coding scheme or both schemes will be described in more detail with reference to FIGS. 3A and 3B. According to one embodiment of the present invention, since the sub-channelizing scheme and the channel coding scheme used for the FCH and the down/up link maps are sent by means of a preamble regularly transmitted through every down link frame, it is unnecessary to follow an essential condition that an initial operation mode be fixed. Accordingly, an initial operation mode is sent through a preamble, and the FCH and the down/up link maps are decoded by using the initial operation mode detected from the preamble. Also, since a sub-channelizing scheme and a channel coding scheme for an OFDM symbol following the FCH and the down/up link maps are sent through the FCH and the down/up link maps, data can be decoded by using the sub-channelizing scheme and the channel coding scheme.

FIGS. 3A and 3B illustrate structures of preamble signals in a frequency domain according to one embodiment of the present invention, FIG. 3A illustrates that a time domain preamble signal pattern is repeated three times, and FIG. 3B illustrates that the time domain preamble signal pattern is repeated two times.

As shown in FIGS. 3A and 3B, according to the present invention, preamble codes of a frequency domain preamble signal are punctured at predetermined positions, and operation mode indicators are inserted into positions of the punctured codes. Herein, one or more puncturing positions may be adjacent to each other or uniformly spread. The puncturing positions can be arranged in various ways.

In FIG. 3A, operation mode indicators for distinguishing operation modes can be inserted into positions of Cₖ₋₃ and Cₖ preamble codes, and in FIG. 3B, operation mode indicators for distinguishing operation modes can be inserted into positions of C₂, C₄, . . . , Cₖ₋₃, Cₖ preamble codes. In detail, according to one embodiment of the present invention, predetermined positions of N codes (two codes in FIG. 3A) from among preamble codes (C₁, . . . , Cₖ) are determined, and transmitted operation mode indicators are inserted into the positions.

Thus, time domain preamble signal patterns repeated three times or two times are maintained. Therefore, it is unnecessary for the reception apparatus to change an original preamble signal structure in which a puncturing operation for an operation mode indicator is not processed. The reception apparatus has only to detect cell/sector information from preamble codes excluding punctured signals.

Also, the reception apparatus decodes information carried by punctured sub-carriers by using previously-known mode information, and determines operation modes according to the decoded information. Herein, the reception apparatus is already aware of the positions of the punctured sub-carriers. In detail, in a case shown in FIG. 3A, the reception apparatus decodes the information carried by the punctured sub-carriers by using operation modes M₁ and M₂ positioned at preamble codes Cₖ₋₃ and Cₖ and determines operation modes according to the information. Also, in a case shown in FIG. 3B, the reception apparatus decodes the information carried by the punctured sub-carriers by using operation modes Mₗ, . . . , M₂ positioned at preamble codes C₂, C₄, . . . , Cₖ₋₃, and Cₖ and determines operation modes according to the information.

In FIG. 3A, since two sub-carriers are assigned to operation mode indicators, the maximum four operation modes can be distinguished. Also, in FIG. 3B, since N sub-carriers are assigned to operation mode indicators, the maximum 2^{N} operation modes can be distinguished.

Hereinafter, structures of a transmission apparatus and a reception apparatus will be described, in which the transmission apparatus generates a preamble having above-described operation mode information and transmits the preamble, and the reception apparatus receives the preamble and detects the operation mode information.

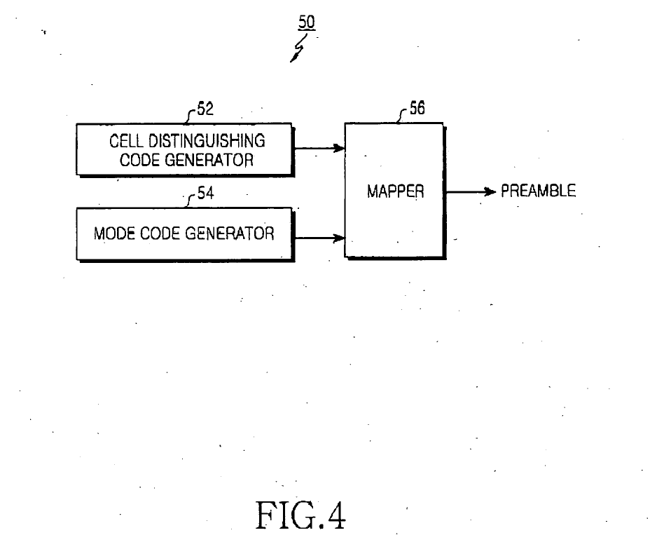

FIG. 4 is a block diagram showing a structure of a transmission apparatus 50 in a wireless communication system according to one embodiment of the present invention. The transmission apparatus 50 includes a cell distinguishing code generator 52 for generating cell distinguishing codes, a mode code generator 54 for generating operation mode codes, and a mapper 56 for mapping the cell distinguishing codes and the operation mode codes to sub-carriers for preambles. The cell distinguishing codes may be preamble codes of a preamble signal in a frequency domain, as are provided by the conventional standard. Also, operation mode codes may be operation mode indicators described above. The mapper 56 punctures preamble codes of a preamble signal in a frequency domain, which are provided from the cell distinguishing code generator 52, at predetermined positions and inserts operation mode codes, which are provided from the mode code generator 54, into the punctured positions. Subsequently, the mapper 56 maps the cell distinguishing codes and the operation mode codes to sub-carriers for a preamble. Moreover, the mapper can change the signs and phase of portions of the total preamble signal codes in the frequency domain by using the othogonal codes, thereby assigning operation mode code information to a preamble signal.

Herein, as described above, one or more puncturing positions may be adjacent to each other, or uniformly spread. The puncturing positions are arranged in various ways.

In the meantime, although the transmission apparatus 50 according to the present invention has the mapper 56, the transmission apparatus 50 may not include the mapper 56. That is, those skilled in the art can understand that all components may transmit cell distinguishing codes and operation mode codes at predetermined positions in place of the mapper 56.

Hereinafter, a structure and an operation of a reception apparatus 60 for receiving a preamble signal having the above-described structure will be described.

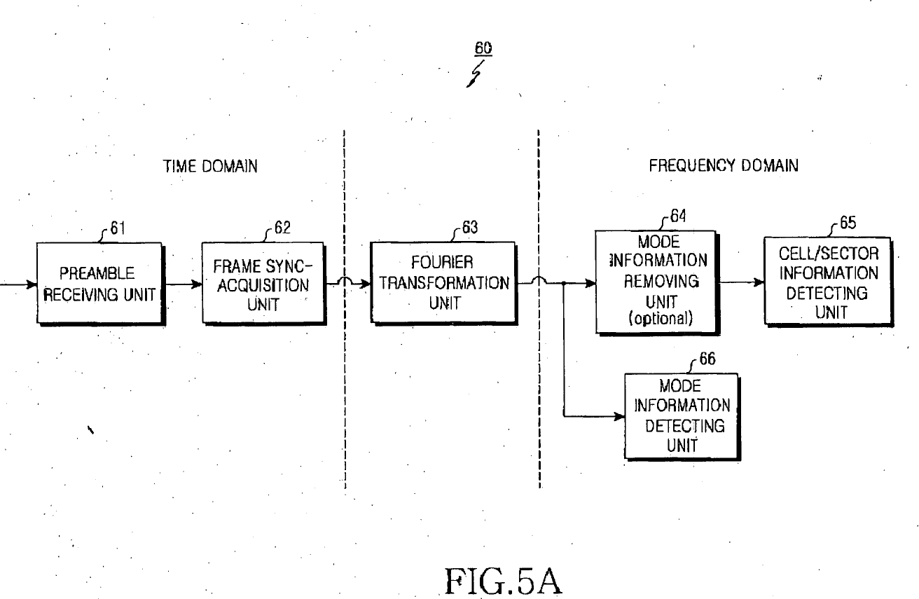

FIG. 5A is a block diagram showing a structure of the reception apparatus 60 in the wireless communication system according to one embodiment of the present invention.

The reception apparatus 60 includes a preamble receiving unit 61 for receiving a preamble signal, a frame sync-acquisition unit 62, a Fourier transformation unit 63, an optional mode information removing unit 64, a cell/sector information detector 65, and a mode information detector 66. The preamble receiving unit 61 receives a preamble signal transmitted from the transmission apparatus 60 and provides the preamble signal to the frame sync-acquisition unit 62. The frame sync-acquisition unit 62 acquires an initial synchronization from the preamble signal, and then provides the preamble signal to the Fourier transformation unit 63. The Fourier transformation unit 63 transforms a preamble signal in a time domain into a preamble signal in a frequency domain and provides the preamble signal in the frequency domain to the mode information removing unit 64 and the mode information detecting unit 66. The mode information removing unit 64 removes operation mode information by inserting 0s into punctured positions carrying mode information of the preamble signal in the frequency domain or by padding the punctured positions with 0s. The mode information removing unit 64 outputs the preamble signal in the frequency domain, in which the mode information has been removed, to the cell/sector information detector 65. In alternative embodiments the Fourier transformation unit 63 outputs the preamble signal in the frequency domain directly to the cell/sector information detecting unit 65 and to the mode information detecting unit 66.

The cell/sector information detector 65 detects preamble codes of the preamble signal given to every cell and every sector and searches for a cell and a sector. At this time, the punctured parts carrying mode information do not exert influence on the search for a cell and a sector. The standard suggests 846 sub-carriers carrying preamble codes of a preamble signal. If a pattern of a time domain preamble signal is repeated two times, the number of available preamble codes is 432. If a pattern of a time domain preamble signal is repeated three times, the number of available preamble codes is 288.

In FIG. 3A, the number of sub-carriers carrying operation mode information is 2 as described above. Accordingly, since two operation mode indicators are much smaller than the available 286 preamble codes obtained by subtracting two operation mode indicators from 288 available overall preamble codes, punctured positions carrying mode information rarely have influence on the search for a cell and a sector. Also, in FIG. 3B, the number of sub-carriers carrying operation mode information is N. Herein, the value of the N is a small number rarely having influence on the search for a cell and a sector.

Also, the mode information detecting unit 66 decodes information sent through a punctured sub-carrier by using previously-known mode information and determines an operation mode according to the information. Herein, the mode information detecting unit 66 previously knows punctured sub-carrier positions. Accordingly, the mode information detecting unit 66 decodes information sent through a punctured sub-carrier by using previously-known mode information, and determines an operation mode according to the information.

The reception apparatus shown in FIG. 5A detects operation mode information through a non-coherent scheme. The reception apparatus 60 shown in FIG. 5B described below, is designed in such that the reception apparatus 60 detects operation mode information through a coherent scheme.

FIG. 5B is a block diagram showing a structure of the reception apparatus 60 in a wireless communication system according to another embodiment of the present invention.

The reception apparatus 60 includes a preamble receiving unit 61 for receiving a preamble signal, a frame sync-acquisition unit 62, a Fourier transformation unit 63, an optional mode information removing unit 64, a cell/sector information detecting unit 65, a channel estimating unit 67, and a mode information detecting unit 66. The reception apparatus shown in FIG. 5B further includes the channel estimating unit 67 as compared with the reception apparatus shown in FIG. 5A. Accordingly, the operations of the preamble receiving unit 61 to the cell/sector information detector 65 are the same as these which have been described with reference to the description of FIG. 5A and therefore, a further description is not necessary.

The reception apparatus shown in FIG. 5B uses a cell/sector code detection result in order to detect an operation mode. The channel estimating unit 67 finds a channel state from the cell/sector code detection result and sends channel information obtained from the channel state to the mode information detecting unit 66. As shown in FIG. 5B, a channel estimation result obtained from the cell/sector information detecting unit 65 is sent as an input of the mode information detecting unit 66. As described above, through the coherent scheme, the mode information detecting unit 66 receives an FFT-preamble signal and a signal outputted from the channel estimating unit 67 through the cell/sector information detecting unit 65, coherently processes the received signals, and detects mode information, thereby enhancing accuracy for detecting the mode information. When the reception apparatus is constructed as described above, a possibility for detecting mode information may increase.

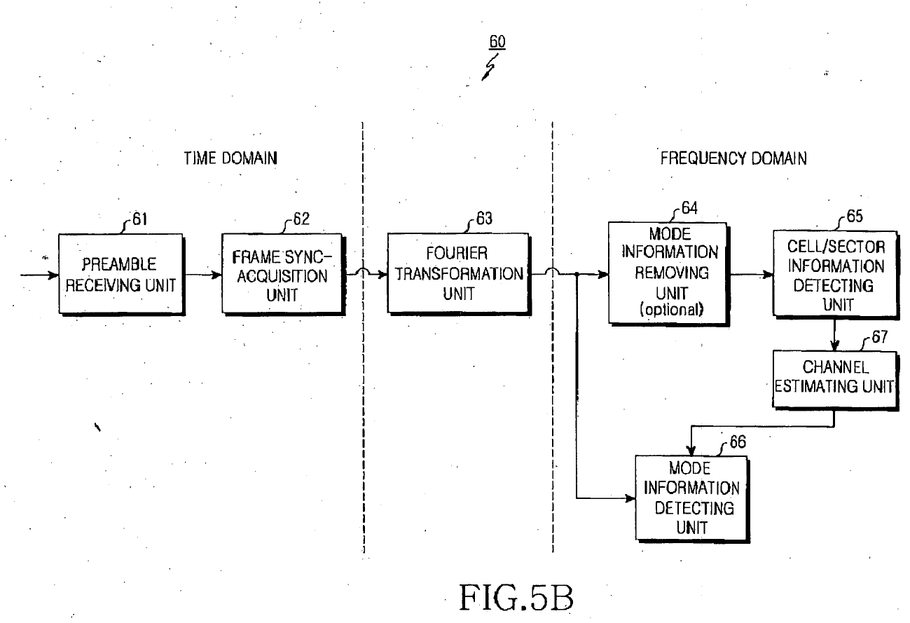

A flow showing a control procedure of the reception apparatus will now be described with reference to FIG. 6, which is a flowchart showing the control procedure of receiving a preamble in the reception apparatus according to one embodiment of the present invention.

The reception apparatus receives a time domain preamble signal in step 72. After that, the reception apparatus performs step 74 so as to acquire a frame synchronization and a frequency synchronization using the time domain preamble signal. Subsequently, the reception apparatus Fourier-transforms the time domain preamble signal into a frequency domain preamble signal in step 76. The frequency domain preamble signal includes mode codes for distinguishing operation modes and preamble codes for distinguishing cells/sectors. Accordingly, the reception apparatus finishes searching for a cell/a sector and an operation mode in step 78.

As described above, according to one embodiment of the present invention, operation mode information is inserted in a frequency domain preamble without changing or manipulating a preamble provided by the conventional IEEE 802.16d standard.

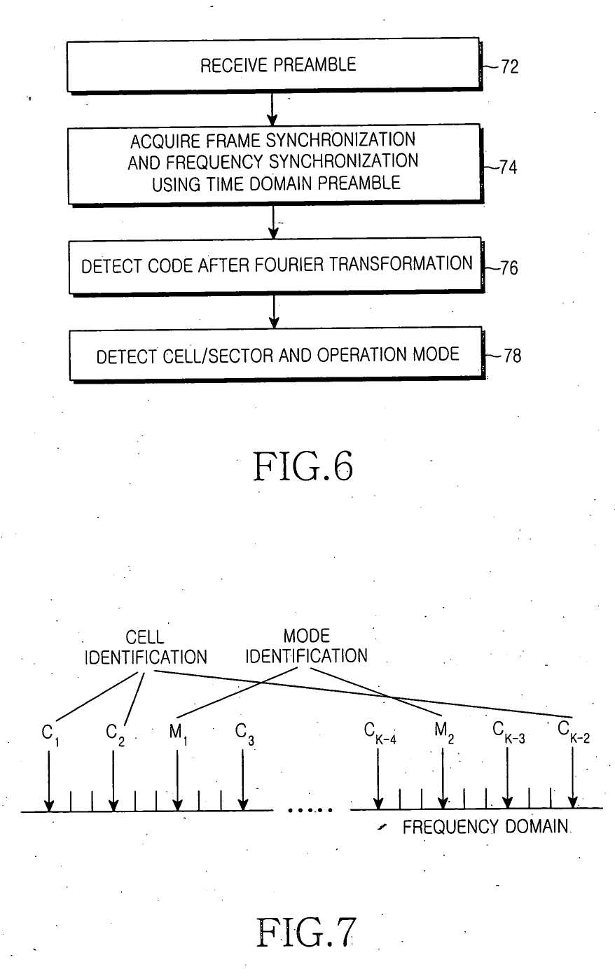

However, according to another embodiment of the present invention, operation mode information can be inserted into a frequency domain preamble signal by changing a preamble signal structure provided by the conventional standard. That is, a puncturing function for operation mode indicators is not performed with respect to a preamble signal in a frequency domain, but sub-carriers can be additionally assigned in order to distinguish operation modes. The above description will be given with reference to FIG. 7.

That is, FIG. 7 illustrates a structure of a preamble signal in the frequency domain according to another embodiment of the present invention, wherein a transmission apparatus assigns additional sub-carriers to operation mode indicators, and sub-carriers of a remaining duration to cell distinguishing codes. In contrast to the embodiment shown in FIGS. 3A and 3B in this embodiment, a cell distinguishing code is newly made up. According the embodiment shown in FIGS. 3A and 3B, a cell distinguishing code of the conventional preamble signal is used in itself, and operation mode information is carried by puncturing a portion of the preamble signal. However, according to another embodiment of the current invention as shown in FIG. 7, a sub-carrier for transmitting a cell distinguishing code and a sub-carrier for transmitting an operation mode code are defined. According to another embodiment of the present invention, if a puncturing function for portions of cell distinguishing codes is not employed in order to insert operation mode codes, but additional sub-carriers for the operation mode codes are employed, the mode information removing unit 64 (as shown in FIGS. 5A and 5B) for padding punctured positions is not required.

As described above, according to embodiments shown in FIGS. 3A, 3B, and 7, although the number of available cell distinguishing codes decreases, it is possible to send operation mode information while minimizing complexity for a reception apparatus.

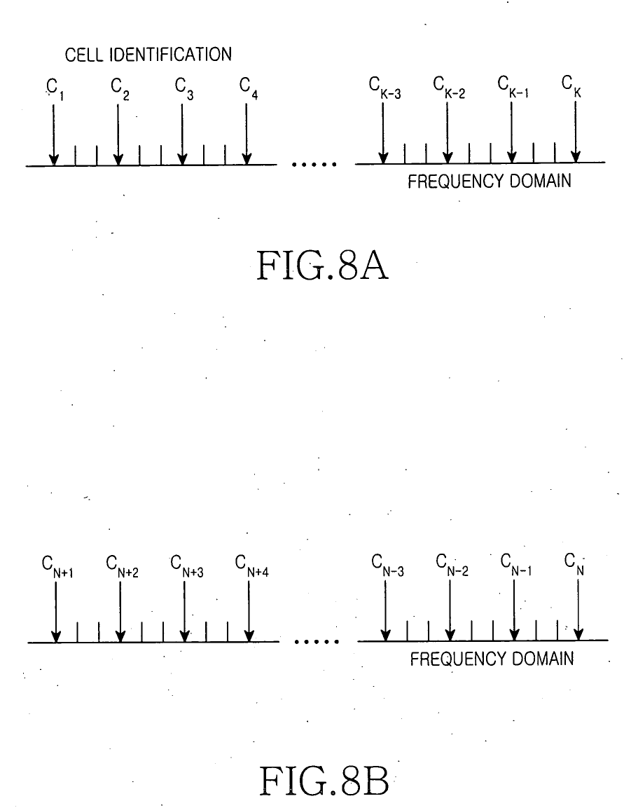

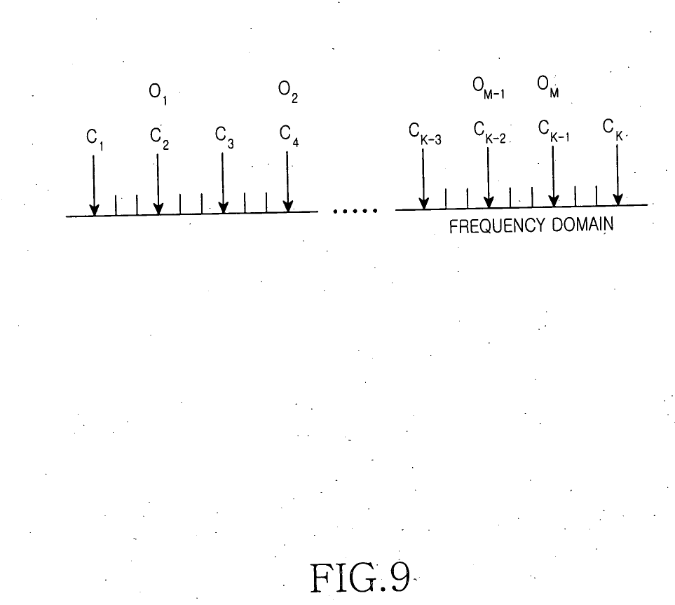

FIGS. 8A and 8B illustrate a structure of a preamble signal in the frequency domain according to still another embodiment of the present invention. Moreover, FIG. 9 illustrates a structure of a preamble signal in the frequency domain according to yet another embodiment of the present invention.

According to another embodiment of the present invention, as shown in FIGS. 8A and 8B, mode information is carried by a preamble signal without changing codes of the preamble signal according to the conventional standard. According to still another embodiment of the present invention, frequency domain codes are cyclic-shifted so as to distinguish each mode. In this case, it is premised that a cyclic-shift amount is greater than frequency offset between a transmission apparatus and a reception apparatus. FIG. 8A illustrates a preamble signal according to the conventional standard. Cell distinguishing codes C₁ to Cₖ (K codes) of the preamble signal in the frequency domain are cyclic-shifted by N so as to have a signal form shown in FIG. 8B. That is, if four operation modes are distinguished, N=f(K/4) may be determined with respect to total K codes. It is noted that f(x) is a function. For example, f(x) can be defined as the largest integer which is not greater than x, etc. Herein, the N has to be determined in such a manner that the value of the N is sufficiently greater than the maximum of frequency offset between a transmission apparatus and a reception apparatus.

According to still another embodiment shown in FIG. 9, M codes from among total K codes are selected and signs of the selected M codes are changed by using orthogonal codes (OVSF codes). It is preferred that the reception apparatus employs the OVSF (indicated by O in FIG. 9) codes changing only signs of the M codes in order to make it easy to perform an operation after performing a correlation. However, it is envisioned that other suitable schemes can be employed in order to improve performance of the reception apparatus and efficiently utilize resources, as desired.

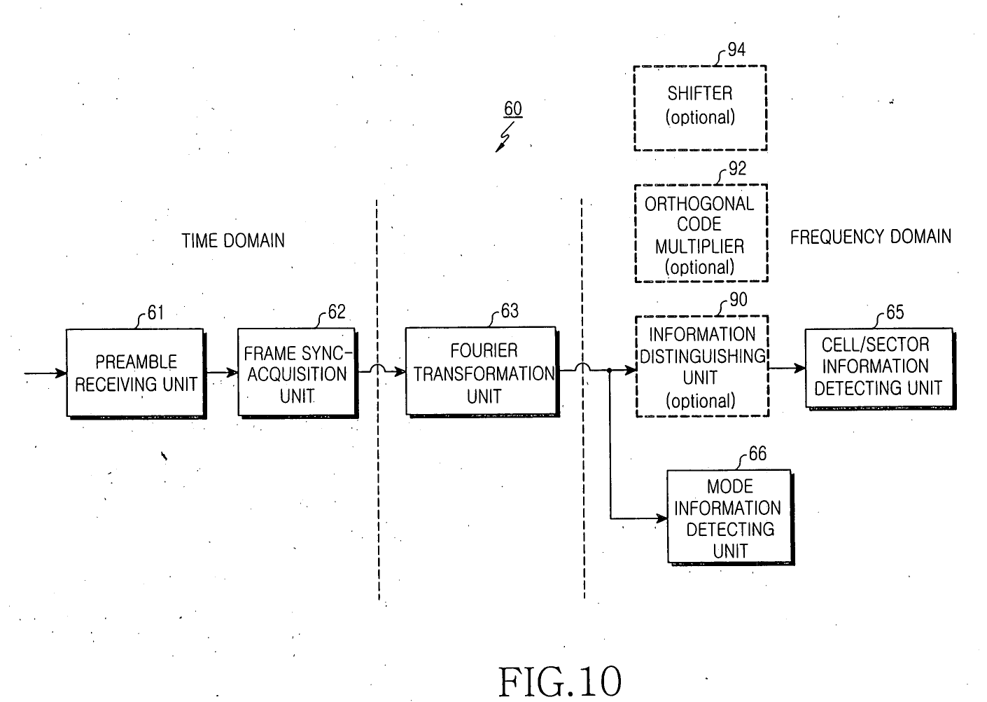

As described above, according to still another embodiments shown in FIGS. 8A and 8B, and 9, since contents of available codes of a preamble signal provided by the conventional standard are not changed, the reception apparatus can obtain available data for searching for a cell/sector according to the conventional standard. FIG. 10 illustrates a structure of the reception apparatus 60 for receiving a preamble signal in a wireless communication system according to still another embodiment of the present invention.

The reception apparatus 60 receiving a preamble signal shown in FIG. 9 includes an information distinguishing unit 90 replacing the optional mode information removing unit 64 of the reception apparatus shown in FIG. 5A. As the operation of similarly numbered elements of the reception apparatus 60 are the same as (unless indicated otherwise) those described elsewhere in this document (e.g., in FIGS. 5A and 5B), further description of their operation will not be made As shown in FIG. 9, the information distinguishing unit 90 distinguishes sub-carriers for transmitting cell distinguishing codes and sub-carriers for transmitting operation mode codes from a preamble signal in the frequency domain received from the Fourier transform unit 63. Herein, the cell/sector information detecting unit 65 and the mode information detecting unit 66 can extract required codes from total codes of the preamble signal in the frequency domain received from the Fourier transform unit 63 without the information distinguishing unit 90.

The reception apparatus 60 receiving a preamble signal shown in FIGS. 8A and 8B includes an optional shifter 94 which replaces the mode information removing unit 64 of the reception apparatus shown in FIG. 5A. The reception apparatus 60 shifts the cyclic-shifted preamble signal in the frequency domain into an original preamble signal by means of the shifter 94.

Also, the reception apparatus 60 receiving a preamble signal shown in FIG. 9 includes an optional orthogonal multiplier 92 which replaces the mode information removing unit 64 of the reception apparatus shown in FIG. 5A. The orthogonal multiplier 92 converts a preamble signal multiplied by the orthogonal code into an original preamble signal.

The reception apparatus for receiving a preamble signal according to the embodiment shown in FIGS. 8A, 8B, and 9 is more complex as opposed to the units shown in FIGS. 5A and 5B in order to provide the ability to search for cyclic shift positions and orthogonal codes. However, since the reception apparatus can receive the preamble signal without additional information loss and performance degradation for cell specific codes, the reception apparatus may be used in a system in which increased performance is desired.

As described above, according to the present invention, since an initial operation mode of an OFDM system is sent through a preamble, it is unnecessary to follow an essential condition defined in the IEEE 802.16d standard in which PUSC (partial usage sub-carriers) are set as an initial operation mode. Accordingly, an initial operation mode can be variably employed according to requirements of communication vendors and developers. As described above, since the initial operation mode is flexibly used, it is possible to reduce resource waste and inefficiency resulting from the set initial operation mode and more efficiently manage a system.

As described above, since an operation mode transmitting and detecting method according to the present invention, does not fixedly set an initial operation mode of a system, but transmits the initial operation mode through a preamble, it is possible to flexibly use operation modes. Also, the IEEE 802.16 standard meeting performing a standardization work can optionally provide various operation modes in down/up links.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A transmission apparatus in a wireless communication system, the transmission apparatus comprising:
a mode code generator for creating operation mode information; and
a mapper for generating and outputting a frequency domain preamble signal including the operation mode information.

2. The transmission apparatus as claimed in claim 1, further comprising a cell distinguishing code generator for creating cell distinguishing information.

3. The transmission apparatus as claimed in claim 1, wherein the mapper performs puncturing with respect to a position of a predetermined signal from among frequency domain preamble signals and inserts the operation mode information into the predetermined signal position.

4. The transmission apparatus as claimed in claim 2, wherein the mapper assigns portions of sub-carriers of the frequency domain preamble signals in order to transmit operation mode information and assigns remaining sub-carriers in order to transmit cell distinguishing codes.

5. The transmission apparatus as claimed in claim 1, wherein the mapper unit cyclic-shifts each code of the frequency domain preamble signal by a predetermined amount and assigns operation mode information to each frequency domain preamble signal according to the predetermined amount of cyclic-shift.

6. The transmission apparatus as claimed in claim 1, wherein the mapper changes signs and phases of portions of total preamble signal codes in the frequency domain by using orthogonal codes, thereby assigning operation mode information to a preamble signal.

7. A reception apparatus in a wireless communication system, the reception apparatus comprising:
a preamble receiving unit for receiving a frequency domain preamble signal; and
a mode information detecting unit for detecting a given operation mode code from the frequency domain preamble signal.

8. The reception apparatus as claimed in claim 7, wherein the frequency domain preamble signal is punctured at a predetermined position and has operation mode information at the predetermined punctured position.

9. The reception apparatus as claimed in claim 8, further comprising a mode information removing unit, wherein the mode information removing unit pads the punctured position carrying operation mode code information of the frequency domain preamble signal with random information.

10. The reception apparatus as claimed in claim 7, further comprising a cell information detecting unit, wherein the cell information detecting unit detects a cell distinguishing code from sub-carriers excluding sub-carriers carrying the operation mode code information in the frequency domain preamble signal.

11. The reception apparatus as claimed in claim 10, further comprising a channel estimating unit, wherein the channel estimating unit finds channel state information from the cell distinguishing code outputted from the cell information detecting unit and provides the channel state information to a mode information detecting unit.

12. The reception apparatus as claimed in claim 7, further comprising a shifter for shifting a cyclic-shifted frequency domain preamble signal into an original signal, wherein all codes of the frequency domain preamble signal are cyclic shifted by a predetermined amount in such manner that the frequency domain preamble signal has operation mode code information according to the predetermined amount of cyclic-shift.

13. The reception apparatus as claimed in claim 7, further comprising an orthogonal code multiplier for returning a preamble code multiplied by an orthogonal code to an original preamble code, wherein portions of total codes of the frequency domain preamble signal are changed by using orthogonal codes in such a manner that the frequency domain preamble signal has each operation mode code information.

14. A method for transmitting a preamble signal in a communication system, the method comprising the steps of:
generating a cell distinguishing code;
generating an operation mode code; and
generating a frequency domain preamble signal by combining the cell distinguishing code with the operation mode code.

15. The method as claimed in claim 14, further comprising the steps of:
puncturing a given position of the frequency domain preamble signal; and
inserting the generated operation mode codes into the punctured position.

16. The method as claimed in claim 14, further comprising the steps of:
allotting portions of overall sub-carriers of the frequency domain preamble signal to operation mode code information; and
allotting remaining sub-carriers of the overall sub-carriers of the frequency domain preamble signal to cell distinguishing codes.

17. The method as claimed in claim 14, further comprising the steps of:
cyclic-shifting each code of the frequency domain preamble signal by a predetermined amount; and
assigning operation mode code information according to the predetermined amount of cyclic-shift.

18. The method as claimed in claim 14, further comprising a step of changing signs or phases of portions of overall codes of the frequency domain preamble signal through orthogonal codes in such a manner that the frequency domain preamble signal has operation mode code information.

19. A method for receiving a preamble signal in a communication system, the method comprising the steps of:
receiving a frequency domain preamble signal; and
searching for an operation mode by using the received frequency domain preamble signal.

20. The method as claimed in claim 19, further comprising the steps of:
removing operation mode code information from the received frequency domain preamble signal; and
detecting cell distinguishing information from a preamble signal in which the operation mode code information is removed.

21. The method as claimed in claim 19, wherein the frequency domain preamble signal is punctured at a predetermined position and has operation mode information at the predetermined position.

22. The method as claimed in claim 19, further comprising a step of removing operation mode code information by padding the punctured position carrying operation mode code information of the frequency domain preamble signal with random information.

23. The method as claimed in claim 19, further comprising a step of cyclic shifting all codes of the frequency domain preamble signal by a predetermined amount in such manner that the frequency domain preamble signal has operation mode information according to a predetermined amount of cyclic-shift and further shifting a cyclic-shifted frequency domain preamble signal into an original signal.

24. The method as claimed in claim 19, further comprising a step of changing portions of total codes of the frequency domain preamble signal by using orthogonal codes in such a manner that the frequency domain preamble signal has operation mode code information and returning a preamble code multiplied by an orthogonal code into an original preamble code.

25. The method as claimed in claim 19, wherein the step of detecting the operation mode includes:
receiving the received preamble signal;
detecting cell/sector information from the received preamble signal;
estimating a channel state from the detected cell/sector information; and receiving the preamble signal and a channel estimation signal, correlating the preamble signal with the channel estimation signal, and searching for the operation mode.

26. A transmission method in a wireless communication system, wherein operation mode code information is carried by a frequency domain preamble signal.

27. A reception method in a wireless communication system, wherein operation mode code information is detected from a received frequency domain preamble signal.
